(19) United States
(12) Patent Application Publication
(10) Pub. No.: US 2023/0243654 A1
(43) Pub. Date: Aug. 3, 2023

(54) NAVIGATION SYSTEMS AND METHODS

(71) Applicant: Animal Dynamics Limited, Oxford (GB)

(72) Inventors: Julian Keri Willis, Oxford (GB); Adrian Thomas, Oxford (GB)

(21) Appl. No.: 18/009,872

(22) PCT Filed: Jun. 8, 2021
(86) PCT No.: PCT/GB2021/051415

§ 371 Date: Dec. 12, 2022

(30) Foreign Application Priority Data
Jun. 12, 2020 (GB) 2008944.7

(51) Int. Cl. G01C 21/00; G01C 21/16; G01C 21/34; G01C 21/08

(52) U.S. Cl. CPC G01C 21/005; G01C 21/16; G01C 21/3469; G01C 21/08

(57) ABSTRACT

In one or more arrangements, navigation system for a vehicle comprises a plurality of sensors which are configured to sense a respective physical property and output a set of physical parameter data which is indicative of the physical property; a weighting module which is configured to generate a weight value for each set of physical parameter data based on at least one further parameter; a memory for storing predetermined physical parameter data and associated predetermined location data; a compiler module which is configured to: rank the sets of physical parameter data according to the weight values, match at least some of the ranked sets of physical parameter data with sets of predetermined physical parameter data which are stored in the memory, generate vehicle location data and compile vehicle navigation data comprising at least one of a bearing or distance from the vehicle to a target.

### FIELD

The present invention relates to navigation systems and methods for a vehicle. The present invention more particularly relates to navigation systems and methods which do not need to rely on a Global Navigation Satellite System (GNSS).

### BACKGROUND

Navigation by GNSS-enabled systems can be energetically expensive, and limited by the requirement for satellite signal, meaning that navigation in some environments (for example indoor or deep sea) is not always possible. GNSS-disabled systems, on the other hand, such as inertial navigation or dead-reckoning can navigate in these environments due to emancipation from satellite signals. These methods, however, often struggle with accuracy due to their inability to determine absolute position in a global coordinate system and are therefore also unable to perform navigation from a ‘cold start’ (i.e. when the system itself must determine its location or starting coordinates).

In the case of unmanned underwater vehicles (UUVs), many existing solutions require the vehicle to stay close to the surface of the water, or at least return to the surface reasonably frequently to receive GNSS input and therefore re-orient itself relative to a target location. This presents numerous detriments, in the form of damage to the UUV due to strong surface currents, conspicuity and fouling of the UUV by bacteria or other organisms as the vehicle stays in the warmer and lighter waters near the surface. Each of these detriments can cause mission failures.

The present invention seeks to provide improved navigation systems and methods which alleviate at least some of the problems outlined herein.

### SUMMARY

According to one aspect of the present invention, there is provided a navigation system for a vehicle, the system comprising: a plurality of sensors, each sensor being configured to sense a respective physical property and to output a set of physical parameter data which is indicative of the physical property; a weighting module which is configured to generate a weight value for each set of physical parameter data based on at least one further parameter; a memory for storing predetermined physical parameter data and associated predetermined location data; a compiler module which is configured to: rank the sets of physical parameter data according to the weight values, match at least some of the ranked sets of physical parameter data with sets of predetermined physical parameter data which are stored in the memory, generate vehicle location data by combining the predetermined location data which is associated with the sets of predetermined physical parameter data according to the respective weight values, and compile vehicle navigation data comprising at least one of a bearing or distance from the vehicle to a target based on the vehicle location data and target location data indicative of the location of the target.

In some embodiments, the at least one further parameter comprises a navigation accuracy parameter which is indicative of a required accuracy for the vehicle navigation data.

In some embodiments, the navigation accuracy parameter changes over time such that: at a first time the navigation accuracy parameter is indicative of a first level of accuracy, and at a second time, which is later than the first time, the navigation accuracy parameter is indicative of a second level of accuracy which is higher than the first level of accuracy.

In some embodiments, the at least one further parameter comprises a speed parameter which is indicative of a speed at which the vehicle is navigating to a target.

In some embodiments, the at least one further parameter comprises a secrecy parameter which is indicative of whether it is acceptable for the vehicle to be observed while the vehicle is navigating to a target.

In some embodiments, the at least one further parameter comprises a longevity parameter which is indicative of the length of time over which the vehicle is navigating to a target.

In some embodiments, the at least one further parameter comprises a fuel parameter which is indicative of the fuel which is available to the vehicle for navigation to a target.

In some embodiments, the plurality of sensors comprise at least one weather sensor which is configured to sense a physical property of the weather in the vicinity of the vehicle.

In some embodiments, the plurality of sensors comprise an acoustic sensor which is configured to sense sound in the vicinity of the vehicle.

In some embodiments, the acoustic sensor is configured to sense sonar in the vicinity of the vehicle when the vehicle is underwater.

In some embodiments, the plurality of sensors comprise a chemical sensor which is configured to sense the level of a chemical in the vicinity of the vehicle.

In some embodiments, the chemical sensor is configured to sense the chemical composition of water in the vicinity of the vehicle when the vehicle is underwater.

In some embodiments, the chemical sensor is configured to sense the salinity of water in the vicinity of the vehicle when the vehicle is underwater.

In some embodiments, the plurality of sensors comprise a camera which is configured to capture images of the environment surrounding the vehicle.

In some embodiments, the camera is configured to capture images celestial bodies using at least one of the visible light spectrum, the infrared spectrum or the ultraviolet spectrum.

In some embodiments, the camera is configured to capture images of the polarised light field of the sun.

In some embodiments, the system further comprises: an image recognition processing module which is configured to perform image recognition on image data provided by the camera.

In some embodiments, the plurality of sensors comprise a flow sensor which is configured to sense the flow of water in the vicinity of the vehicle when the vehicle is underwater.

In some embodiments, the plurality of sensors comprise a magnetic field sensor which is configured to sense the intensity of the Earth's magnetic field at the location of the vehicle.

In some embodiments, the magnetic field sensor is configured to sense the inclination of the Earth's magnetic field at the location of the vehicle.

In some embodiments, the system is configured to calculate the timing of the quiet diurnal variation (QDV) of the Earth's magnetic field using the sensed intensity and/or inclination of the Earth's magnetic field.

In some embodiments, the plurality of sensors comprise a temperature sensor which is configured to sense a temperature in the vicinity of the vehicle.

In some embodiments, the plurality of sensors comprise a depth sensor which is configured to sense the depth of the vehicle when the vehicle is underwater.

In some embodiments, the depth sensor comprises at least one of a pressure sensor, a sonar device or a laser range finder.

In some embodiments, the system further comprises: an inertial navigation module which is configured to record the acceleration of the vehicle over time and to output inertial navigation data as physical parameter data.

In some embodiments, the plurality of sensors comprise a power supply sensor which is configured to sense a physical property of a power supply carried by the vehicle.

In some embodiments, the predetermined physical parameter data and associated predetermined location data comprise at least one of tidal data, geomagnetic anomaly data or light level data based on the sun or moon rise and set.

In some embodiments, the system is configured to compile the vehicle navigation data based on predetermined tidal data to control the navigation of the vehicle such that a tidal stream assists with the propulsion of the vehicle.

According to another aspect of the present invention, there is provided a vehicle comprising the navigation system of any one of claims 1 to 28 as defined hereinafter.

According to a further aspect of the present invention, there is provided a navigation method for a vehicle, the method comprising: sensing a plurality of physical properties and providing a plurality of sets of physical parameter data, each set of physical parameter data being indicative of one of the physical properties; generating a weight value for each set of physical parameter data based on at least one further parameter; ranking the sets of physical parameter data according to the weight values; matching at least some of the ranked sets of physical parameter data with sets of predetermined physical parameter data which are stored in a memory, the memory storing predetermined physical parameter data and associated predetermined location data; generating vehicle location data by combining the predetermined location data which is associated with the sets of predetermined physical parameter data according to the respective weight values; and compiling vehicle navigation data comprising at least one of a bearing or distance from the vehicle to a target based on the vehicle location data and target location data indicative of the location of the target.

### BRIEF DESCRIPTION OF THE DRAWINGS

In order that the invention may be more readily understood, and so that further features thereof may be appreciated, embodiments of the invention will now be described, by way of example, with reference to the accompanying drawings in which:

FIG. 1 is a schematic diagram showing a navigation system of some embodiments.

### DETAILED DESCRIPTION

Animals are capable of travelling long distances without access to GNSS information and can often navigate in complete darkness. It is suspected that many species which are capable of long-distance travel have some form of magnetic sense and are thereby able to determine their position relative to a desired location. This suggests that variations in the intensity or orientation of the Earth's magnetic field may provide sufficient information to determine a required bearing upon which to travel to reach a desired location. Other studies from animals (e.g. salmon) have demonstrated that they are capable of remembering locations based on the local magnetic field intensity, which implies that it may also be possible to estimate the absolute position of a system in terms of global coordinates.

The systems and methods described herein take inspiration from studies of navigation of animals to address technical problems with navigating vehicles in challenging environments.

True navigation implies movement to a target location (e.g. known target location) from a current location that may not have been visited before. The least information required is a direction of travel with respect to a fixed heading, but a more useful set of information is a direction and a distance to target. The usual theoretical approach is to split true navigation into two steps: a map step, and a compass step. The map step is used to determine the bearing and distance to the target and the compass step is used to attempt to travel in the correct direction.

For a two-dimensional map, two scalar components are required to form a heading vector for navigation. The normal example is latitude and longitude. These are the most often used two components (or coordinates) in the standard bi-coordinate map system. If two scalar values are known (one number for latitude and one for longitude) for the current location of a vehicle and the same two are known for a target location, it is possible to plot a heading from the current location to the target location with respect to geographic north. This is because the latitude and longitude are always orthogonal (and never parallel) to each other and they both have a gradient which is a direction (a vector quantity) that is always consistent with respect to geographic north.

A compass points to magnetic north and so there needs to be some adjustment for correct navigation. A map of declination for every point on the Earth's surface is needed in order to achieve a perfect bearing every time. Generally declination changes slowly over most of the Earth's surface and is consistent over several years, but for precise navigation a change in declination is an important factor.

Alternatives for latitude and longitude can be thought of as proxies for latitude and longitude. For instance, the position of the sun in the sky (height above the horizon at a certain time) is a good proxy for longitude. In the same way the fixed stars and moon can be used as a proxy for longitude—there are examples of animals using a sun clock based compass and navigating by the position of the Milky Way for instance. There are many animals that have been shown to have an inclination compass, and magnetic inclination is a good proxy for latitude. However, unlike animals, as described below some embodiments are configured to measure and model many different physical cues across the world and use them as (local) proxies for latitude and longitude.

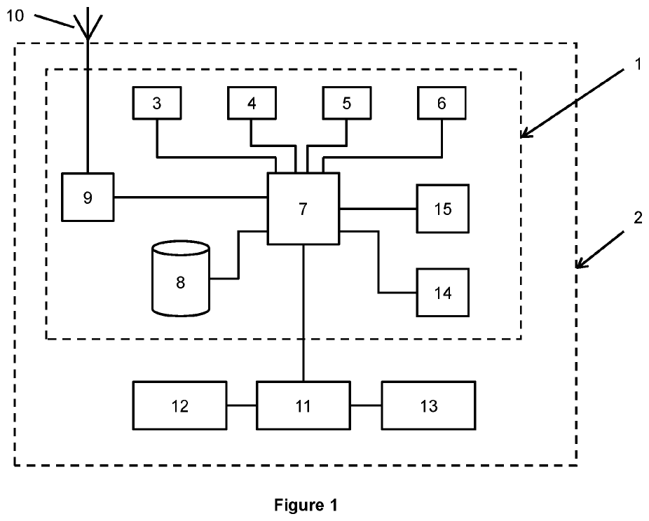

Referring now to FIG. 1 of the accompanying drawings, a navigation system 1 of some embodiments is installed within a vehicle 2. In the embodiment shown in FIG. 1, the navigation system 1 is integrated within the vehicle 2. However, in other embodiments, the navigation system is a self-contained device or a collection of devices which are configured to be carried by a vehicle in order to provide a navigation system for the vehicle.

The vehicle 2 may be any type of vehicle which may be configured to travel across land, across water, underwater or by air. In some embodiments, the vehicle 2 is an autonomous or semi-autonomous vehicle which is configured to navigate autonomously to a target location.

In some embodiments, the vehicle 2 is an unmanned underwater vehicle (UUV). In other embodiments, the vehicle 2 is an unmanned air vehicle (UAV). In further embodiments, the vehicle 2 is an autonomous or semi-autonomous land vehicle.

The system 1 comprises a plurality of sensors 3-6. In the embodiment shown in FIG. 1, there are four sensors 3-6 but in other embodiments there are a greater or lower number of sensors.

Each sensor 3-6 is configured to sense a respective physical property and to output a set of physical parameter data which is indicative of the physical property.

In some embodiments, the sensors 3-6 comprise at least one weather sensor which is configured to sense a physical property of the weather in the vicinity of the vehicle 2.

In some embodiments, the sensors 3-6 comprise at least one acoustic sensor which is configured to sense sound in the vicinity of the vehicle 2. In some embodiments, the acoustic sensor is configured to sense sonar in the vicinity of the vehicle 2 when the vehicle 2 is underwater. In some embodiments, the at least one acoustic sensor is configured to sense passive acoustics which are indicative of physical properties of the underwater environment in the vicinity of the vehicle 2, such as shipping lanes, coastal features, islands or bridge piers.

In some embodiments, the sensors 3-6 comprise at least one chemical sensor which is configured to sense the level of a chemical in the vicinity of the vehicle 2. In some embodiments, the chemical sensor is configured to sense the chemical composition of water in the vicinity of the vehicle 2 when the vehicle 2 is underwater. In some embodiments, the chemical sensor is configured to sense the salinity of water in the vicinity of the vehicle 2 when the vehicle 2 is underwater. In some embodiments, the at least one chemical sensor is configured for analysis or water sampling on board the vehicle 2 for use in rivers or estuaries.

In some embodiments, the sensors 3-6 comprise at least one camera which is configured to capture images of the environment surrounding the vehicle 2. In some embodiments, the at least one camera is configured to capture images of celestial bodies, such as the sun, moon and/or stars, using at least one of the visible light spectrum, the infrared spectrum or the ultraviolet spectrum. The physical parameter data from the at least one camera can be compared with look up tables or models for the sun, moon and in order to derive location information which is indicative of the location of the vehicle 2. In some embodiments, the at least one camera is configured to capture images of the polarised light field of the sun since the polarised light field of the sun is especially useful for establishing the direction of geographic north at certain times of day.

In some embodiments, the system further comprises an image recognition processing module which is configured to perform image recognition on image data provided by the camera. In some embodiments, the image recognition module is configured to recognize coastline in the image data provided by the camera.

In some embodiments, the sensors 3-6 comprise at least one flow sensor which is configured to sense the flow of water in the vicinity of the vehicle 2 when the vehicle 2 is underwater. In some embodiments, the at least one flow sensor is configured to sense the currents or tides in the vicinity of the vehicle 2. In these embodiments, the system is configured to measure the tidal pattern (i.e. the rule of twelfths) when the vehicle 1 is positioned on the bottom of the sea bed near a shore. The measured tidal data can then be compared with predetermined tidal data (e.g. using a tidal look up table) to establish the location of the vehicle 1. In addition, in some embodiments the system is configured to examine the direction of the tide to help identify location.

In some embodiments, the sensors 3-6 comprise at least one magnetic field sensor which is configured to sense the intensity of the Earth's magnetic field at the location of the vehicle 2. In some embodiments, the magnetic field sensor is configured to sense the inclination of the Earth's magnetic field at the location of the vehicle 2. In some embodiments, the system is configured to calculate the timing of the quiet diurnal variation (QDV) of the Earth's magnetic field using the sensed intensity and/or inclination of the Earth's magnetic field. The QDV of the Earth's magnetic field changes predictably during the day and therefore can be used as a proxy for longitude to help identify the location of the vehicle 2.

The QDV of the Earth's magnetic field is something that happens at a specific time of day, dependent on where you are in the world. It can be measured and thus if the vehicle has an on board clock then it can detect the point at which the QDV happens and can compare it to when it is expected to happen (e.g. using a look up table). For example, if we know that the QDV happens at 05:30 am every day at a specific point in the world, but the system measures the QDV actually occurring at 05:00 am, then the system can deduce information about its location i.e. the vehicle is West or East of where the system originally anticipated for its current location.

In some embodiments, the sensors 3-6 comprise at least one temperature sensor which is configured to sense a temperature in the vicinity of the vehicle 2.

In some embodiments, the sensors 3-6 comprise at least one depth sensor which is configured to sense the depth of the vehicle 2 when the vehicle 2 is underwater. In some embodiments, the at least one depth sensor is a pressure sensor, a sonar device or a laser range finder. A sonar ping from a sonar device up to the surface is more reliable in low depth and especially important for tidal monitoring. Whereas, a laser range finder is less conspicuous than sonar pings.

As will be described in more detail below, the physical parameter data from the sensors 3-6 can be compared with predetermined observations, models or maps in order to derive location information which is indicative of the location of the vehicle 2.

In some embodiments, the system further comprises an inertial navigation module which is configured to record the acceleration of the vehicle 2 over time and to output inertial navigation data as physical parameter data.

In some embodiments, the sensors 3-6 comprise at least one power supply sensor which is configured to sense a physical property of a power supply carried by the vehicle 2.

Returning now to FIG. 1 of the accompanying drawings, the system 1 further comprises a central processing unit 7 which is coupled for communication with a memory 8. Each of the sensors 3-6 is coupled to the central processing unit 7 so that the central processing unit 7 can receive and process the physical parameter data which is output from the sensors 3-6.

The memory 8 is configured to store data to be processed by the central processing unit 7 as well as data which is transmitted from the central processing unit 7 to the memory 8. In some embodiments, the memory 8 stores predetermined physical parameter data and associated predetermined location data. The predetermined physical parameter data and associated predetermined location data is predetermined data which is stored as a model or a database in the memory 8. In some embodiments, the predetermined physical parameter data and associated predetermined location data comprises at least one of tidal data, geomagnetic anomaly data or light level data based on the sun or moon rise and set. In some embodiments, the predetermined physical parameter data and associated predetermined location data comprises a magnetic model of the Earth's main magnetic field for any location and time and a model of the QDV for any location and time. In some embodiments, the predetermined physical parameter data and associated predetermined location data comprises models of other fixed or variable (in space and time) magnetic field anomalies.

In some embodiments, the system comprises a communication module 9 which is coupled for communication with the central processing unit 7. In some embodiments, the communication module 9 is coupled to a communication means, such as an antenna 10 to enable the system to communicate wirelessly with another system, for instance to control the vehicle 2 or to receive data from the vehicle 2. In some embodiments, the communication module 9 is configured to communication with a communication module of another vehicle, for instance to share navigation data so that the vehicles can navigate together as a fleet.

In some embodiments, the system comprises a wired connection socket which is coupled to the communication module 9 to enable another system to be connected to the system by wire in order to program the vehicle 2 for navigation prior to launching the vehicle on a mission.

In some embodiments, the central processing unit 7 or another part of the system 1 is coupled to a vehicle control module 11 so that the system 1 can control the movement and navigation of the vehicle 2. In these embodiments, the vehicle control module 11 uses navigation data which is output by the system 1 to control the movement of the vehicle 2. The vehicle control module 11 is coupled to a vehicle drive unit 12, such as a motor, to move the vehicle 2 and a vehicle steering unit 13 is configured to steer the vehicle 2.

In some embodiments, the system 1 is configured to generate inertial navigation data by recording the path travelled by the vehicle 2. This inertial navigation data may be used to support or validate navigation data derived by the system 1.

The system 1 further comprises a weighting module 14 which is coupled for communication with the central processing unit 7. The weighting module 14 is configured to generate a weight value for each set of physical parameter data based on at least one further parameter.

The weighting module 14 is configured to generate the weight values based on at least one further parameter according to requirements for the navigation of the vehicle 2. In some embodiments, the requirements for the navigation of the vehicle 2 are mission planning requirements including at least one of location accuracy, speed, secrecy or longevity for the vehicle during a mission. These requirements are discussed in further detail below.

The system 1 further comprises a compiler module 15 which is coupled for communication with the central processing unit 7. The compiler module 15 is configured to rank the sets of physical parameter data from the sensors 3-6 according to the weight values which are generated by the weighting module 14.

The compiler module 15 is configured to match at least some of the ranked sets of physical parameter data with sets of predetermined physical parameter data which are stored in the memory 8. The compiler module 15 is configured to generate vehicle location data by combining the predetermined location data which is associated with the sets of predetermined physical parameter data according to the respective weight values. The compiler module 15 is also configured to compile vehicle navigation data comprising at least one of a bearing or distance from the vehicle 2 to a target based on the vehicle location data and target location data indicative of the location of the target.

In some embodiments, the at least one further parameter comprises a navigation accuracy parameter which is indicative of a required accuracy for the vehicle navigation data. For instance, the accuracy of the start and finish locations of the vehicle. A high of level of navigation accuracy may be required when the vehicle is in close proximity to objects such as coastlines, and a low level of navigation accuracy may be acceptable if the vehicle is far from any objects, such as far out in the ocean.

In some embodiments, the navigation accuracy parameter changes over time such that at a first time the navigation accuracy parameter is indicative of a first level of accuracy, and at a second time, which is later than the first time, the navigation accuracy parameter is indicative of a second level of accuracy which is higher than the first level of accuracy.

In some embodiments, the at least one further parameter comprises a speed parameter which is indicative of a speed at which the vehicle is navigating to a target. For instance, the speed parameter may indicate a high speed in which the fastest possible route might not be the shortest distance and there may be no time available for the navigation system to survey the local area. Conversely, the speed parameter may indicate a low speed in which the slowest route might be the shortest distance and time may be available for the navigation system to survey the local area.

In some embodiments, the at least one further parameter comprises a secrecy parameter which is indicative of whether it is acceptable for the vehicle to be observed while the vehicle is navigating to a target. For instance, the secrecy parameter may indicate a high level of secrecy if the vehicle cannot be observed (e.g. above the water line) or a low level of secrecy it is acceptable for the vehicle to be observed. If the secrecy requirement is low and the vehicle 2 is underwater then the vehicle 2 can surface to take GPS measurements but if it is high then the vehicle 2 must remain below a certain depth (e.g. sitting on the sea bed monitoring tidal currents, other currents, surface height, acoustics, light levels or magnetic patterns).

In some embodiments, the at least one further parameter comprises a longevity parameter which is indicative of the length of time over which the vehicle is navigating to a target. For instance, the longevity parameter may indicate a high level of longevity if the vehicle must avoid situations that might be detrimental to longevity of the vehicle, such as surface waters which can lead to fowling and potential damage due to localised currents or foreign objects. Conversely, the longevity parameter may indicate a low level of longevity if the vehicle is being used for a short mission.

In some embodiments, the at least one further parameter comprises a fuel parameter which is indicative of the fuel which is available to the vehicle for navigation to a target. In some embodiments, the system 1 is configured to modify the navigation of the vehicle 2 if the fuel parameter is indicative of the available fuel being below a predetermined level. For instance, the system 1 may be configured to navigate the vehicle 2 to make use of tidal currents for propulsion in order to reduce fuel consumption.

In some embodiments, the system 1 is configured to modify the weighting values generated by the weighting module 14 if the at least one further parameter changes. For instance the at least one further parameter may change depending on the mission planning.

In one example mission, the start point of the vehicle 2 is close to a coastline, so the accuracy of the start point needs to be high. In this example, the mission also requires a high level of secrecy as the vehicle cannot be observed. The speed to target is low and the vehicle is required for multiple missions, so a high level of longevity is necessary.

In another example mission, the finish point of the vehicle 2 is in the middle of the ocean, so the location accuracy can be lower. Secrecy at this point is not required but longevity of the vehicle 2 is still essential so the vehicle cannot surface and risk fouling/damage due to surface currents.

In a further example mission, the accuracy of location changes mid-mission as does the secrecy requirement but the speed requirement is not high so any amount of time can be taken to establish each level of location accuracy.

In the embodiments described above which are configured to measure tidal data, the system of some embodiments is configured to use the measured tidal data to determine the tidal stream in the vicinity of the vehicle 1. Tidal behaviour is well known, predictable and modelled. The system 1 can therefore use known tidal behaviour to assist with mission execution. For instance, in some embodiments the system is configured to measure tidal data and use the tidal data to determine an optimum time to launch the vehicle into the tidal stream, for instance to move along a coast. In these embodiments, the system enables Selective Tidal Stream Transport by using the knowledge of the tides to make use of fast or slow moving tidal streams according to mission requirement for the vehicle. Additionally, tidal streams can be used as a form of propulsion for the vehicle to improve the fuel economy of the vehicle.

While the embodiments described above are configured to operate without needing to rely on a GNSS, such as GPS, the system of some embodiments is equipped with a GNSS receiver to enable the system to navigate using a GNSS when possible. However, these embodiments do not necessarily require the presence of a GNSS for navigation.

The systems of some embodiments system provide a ‘cold start’ functionality that increases the utility of the system, allowing it to accurately recommence navigation even after a period of inactivity.

While the embodiments described above are described in terms of a system, it is to be appreciated that the description also encompasses embodiments in the form of a method of operating the system.

The present disclosure provides many different embodiments, or examples, for implementing different features of the provided subject matter. Specific examples of components, concentrations, applications and arrangements are described below to simplify the present disclosure. These are, of course, merely examples and are not intended to be limiting. For example, the attachment of a first feature and a second feature in the description that follows may include embodiments in which the first feature and the second feature are attached in direct contact, and may also include embodiments in which additional features may be positioned between the first feature and the second feature, such that the first feature and the second feature may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In addition, while a particular feature of the disclosure may have been disclosed with respect to only one of several implementations, such feature may be combined with one or more other features of the other implementations as may be desired and advantageous for any given or particular application.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B.

Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described features (e.g., elements, resources, etc.), the terms used to describe such features are intended to correspond, unless otherwise indicated, to any features which performs the specified function of the described features (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

Embodiments of the subject matter and the functional operations described herein can be implemented in digital electronic circuitry, or in computer software, firmware, or hardware, including the structures disclosed in this specification and their structural equivalents, or in combinations of one or more of them.

Some embodiments are implemented using one or more modules of computer program instructions encoded on a computer-readable medium for execution by, or to control the operation of, a data processing apparatus. The computer-readable medium can be a manufactured product, such as hard drive in a computer system or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The terms “computing device” and “data processing apparatus” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A navigation system for a vehicle, the system comprising:
a plurality of sensors, each sensor being configured to sense a respective physical property and to output a set of physical parameter data which is indicative of the physical property;
a weighting module which is configured to generate a weight value for each set of physical parameter data based on at least one further parameter;
a memory for storing predetermined physical parameter data and associated predetermined location data;
a compiler module which is configured to:
rank the sets of physical parameter data according to the weight values,
match at least some of the ranked sets of physical parameter data with sets of predetermined physical parameter data which are stored in the memory,
generate vehicle location data by combining the predetermined location data which is associated with the sets of predetermined physical parameter data according to the respective weight values, and
compile vehicle navigation data comprising at least one of a bearing or distance from the vehicle to a target based on the vehicle location data and target location data indicative of the location of the target.

2. The system of claim 1, wherein the at least one further parameter comprises a navigation accuracy parameter which is indicative of a required accuracy for the vehicle navigation data.

3. The system of claim 2, wherein the navigation accuracy parameter changes over time such that:
at a first time the navigation accuracy parameter is indicative of a first level of accuracy, and
at a second time, which is later than the first time, the navigation accuracy parameter is indicative of a second level of accuracy which is higher than the first level of accuracy.

4. The system of claim 1, wherein the at least one further parameter is selected from a group including a speed parameter which is indicative of a speed at which the vehicle is navigating to a target, or
a secrecy parameter which is indicative of whether it is acceptable for the vehicle to be observed while the vehicle is navigating to a target, or
a longevity parameter which is indicative of a length of time over which the vehicle is navigating to a target, or
a fuel parameter which is indicative of the fuel which is available to the vehicle for navigation to a target.

5-7. (canceled)

8. The system of claim 1, wherein the plurality of sensors are selected from a group including a weather sensor which is configured to sense a physical property of the weather in the vicinity of the vehicle, or
an acoustic sensor which is configured to sense sound in the vicinity of the vehicle, or
a chemical sensor which is configured to sense a level of a chemical in the vicinity of the vehicle, or
a camera which is configured to capture images of the environment surrounding the vehicle, or
a flow sensor which is configured to sense the flow of water in the vicinity of the vehicle when the vehicle is underwater, or
a magnetic field sensor which is configured to sense the intensity of the Earth's magnetic field at the location of the vehicle, or
a temperature sensor which is configured to sense a temperature in the vicinity of the vehicle, or
a depth sensor which is configured to sense the depth of the vehicle when the vehicle is underwater, or
a power supply sensor which is configured to sense a physical property of a power supply carried by the vehicle.

9. (canceled)

10. The system of claim 8, wherein the acoustic sensor is configured to sense sonar in the vicinity of the vehicle when the vehicle is underwater.

11. (canceled)

12. The system of claim 8, wherein the chemical sensor is configured to sense the chemical composition of water in the vicinity of the vehicle when the vehicle is underwater.

13. The system of claim 8, wherein the chemical sensor is configured to sense the salinity of water in the vicinity of the vehicle when the vehicle is underwater.

14. (canceled)

15. The system of claim 8, wherein the camera is configured to capture images celestial bodies using at least one of the visible light spectrum, the infrared spectrum or the ultraviolet spectrum.

16. The system of claim 8, wherein the camera is configured to capture images of the polarised light field of the sun.

17. The system of claim 8, wherein the system further comprises:
an image recognition processing module which is configured to perform image recognition on image data provided by the camera.

18. (canceled)

19. The system of claim 8, wherein the plurality of sensors comprise a magnetic field sensor which is configured to sense the intensity of the Earth's magnetic field at the location of the vehicle.

20. The system of claim 8, wherein the magnetic field sensor is configured to sense the inclination of the Earth's magnetic field at the location of the vehicle.

21. The system of claim 8, wherein the system is configured to calculate the timing of the quiet diurnal variation (QDV) of the Earth's magnetic field using the sensed intensity and/or inclination of the Earth's magnetic field.

22-23. (canceled)

24. The system of claim 8, wherein the depth sensor comprises at least one of a pressure sensor, a sonar device or a laser range finder.

25. The system of claim 1, wherein the system further comprises:
an inertial navigation module which is configured to record the an acceleration of the vehicle over time and to output inertial navigation data as physical parameter data.

26. (canceled)

27. The system of claim 1, wherein the predetermined physical parameter data and associated predetermined location data comprise at least one of tidal data, geomagnetic anomaly data or light level data based on the sun or moon rise and set.

28. The system of claim 27, wherein the system is configured to compile the vehicle navigation data based on predetermined tidal data to control the navigation of the vehicle such that a tidal stream assists with the propulsion of the vehicle.

29. A vehicle comprising the navigation system of claim 1.

30. A navigation method for a vehicle, the method comprising:
sensing a plurality of physical properties and providing a plurality of sets of physical parameter data, each set of physical parameter data being indicative of one of the physical properties;
generating a weight value for each set of physical parameter data based on at least one further parameter;
ranking the sets of physical parameter data according to the weight values;
matching at least some of the ranked sets of physical parameter data with sets of predetermined physical parameter data which are stored in a memory, the memory storing predetermined physical parameter data and associated predetermined location data;
generating vehicle location data by combining the predetermined location data which is associated with the sets of predetermined physical parameter data according to the respective weight values; and
compiling vehicle navigation data comprising at least one of a bearing or distance from the vehicle to a target based on the vehicle location data and target location data indicative of the location of the target.
